(19) United States
(12) Patent Application Publication
(10) Pub. No.: US 2004/0171485 A1
(43) Pub. Date: Sep. 2, 2004

(54) Laser recording type heat sensitive recording element

(76) Inventors: Tomoaki Nagai, Kita-ku (JP); Takashi Date, Kita-ku (JP); Yuji Tsuzuki, Kita-ku (JP); Yoshihide Kimura, Kita-ku (JP)

Correspondence Address: Sherman & Shalloway, 413 N Washington Street, Alexandria, VA, 22314, US

(21) Appl. No.: 10/477,350

(22) PCT Filed: May 24, 2002
(86) PCT No.: PCT/JP02/05055

(30) Foreign Application Priority Data
May 25, 2001 (JP) 2001-157979

(51) Int. Cl. B41M 5/20

(52) U.S. Cl. 503/201

(57) ABSTRACT

The present invention provides a laser recording thermally sensitive recording medium comprising a thermally sensitive recording layer containing at least a photo absorbing material which absorbs laser ray and covert it to heat, an electron donning leuco dye and an electron accepting color developing agent on a substrate, wherein said electron donning leuco dye contains a leuco dye which absorbs the ray of visible range and a leuco dye having main wave length of absorption at the ray of 600 nm or longer.

### FIELD OF THE INVENTION

The present invention relates to a laser recording thermally sensitive recording medium which records image by laser ray irradiation.

### BACKGROUND OF THE INVENTION

Among direct recording methods which do not need a developing or a fixing process, a thermally sensitive recording material using an electron donning leuco dye and an electron accepting color developing agent as the coloring agents is broadly applied for a facsimile use or for a printer use because of it's excellent easy handling and good preservability. However, this method uses a thermal head or an exothermic IC pen and records image thermally by contacting these tools to thermally sensitive recording medium, therefore the following points are pointed out as the problems. That is, color developed melted subject is stuck to the thermal head or to the exothermic IC pen and causes troubles such as deposit of scum or sticking, and it becomes to a cause of the disablement of record or spoils the quality of recorded image. In particular, in the case of a plotter printer which draws a line continuously along with the flow direction of record, the continuous printing without causing a trouble such as deposit of scum is actually impossible. Further, in the case of recording method by using a thermal head, it is generally said that it is difficult to elevate the image resolving degree over than 8 lines/mm.

As a method to dissolve the trouble such as deposit of scum or sticking and improve the image resolving degree, a non-contact recording method by ray is proposed. In Japanese Patent Laid Open Publication 54-4142, the following art is disclosed. That is, in the thermally sensitive recording medium, on the substrate of which a thermally sensitive coloring layer mainly composed of leuco dye is coated, the thermal recording becomes possible because by using a metal compound possessing a lattice defect, said metal compound absorbs visual and infra red ray, and converts the absorbed ray to heat.

Further, in JP Laid Open Publication 58-209594, a photo recording medium formed by coating at least one combination of a near-infrared ray absorbing agent having absorbing wave length at 0.8-2 μm near-infrared range and a thermally sensitive coloring material on a substrate is disclosed, and in JP Laid Open Publication 58-94494, a recording medium which coats on a substrate one or more thermally sensitive coloring material and one or more near-infrared ray absorbing agent having maximum absorbing wave length at 0.7-3 μm near-infrared region is disclosed. These publications disclose that the recording to these recording medium can be carried out by a hot plate or by laser ray having wave length at near-infrared range.

Above mentioned JP Laid Open Publication 58-94494 and JP Laid Open Publication 58-209594 disclose that the photo absorbing thermally sensitive coloring layer is obtained by adding directly a near-infrared ray absorbing agent to the coating for thermally sensitive coloring layer, then coating it and drying. However, since the near-infrared ray absorbing agents to be used are generally fairly colored, the ground color is not so good, further, when the near-infrared ray absorbing agent is contained in the thermally sensitive coloring layer, the sufficient coloring density can not be obtained, because the deteriorating effect to the thermally sensitive coloring material is caused. As the countermeasure, a method to contain the near-infrared ray absorbing agent in a separated layer from the thermally sensitive coloring layer and to use by laminating these layers is proposed, however, the multi layered structure is not advantageous from the view point of the manufacturing.

In the meanwhile, recently, in the plate making method for newspaper, the use of a dry film which records image by laser is becoming popular in place of a conventional printing paper. In general, a newspaper article is output as an electronic information to a printing paper (a silver salt film), developed and fixed. Then, the obtained printing paper is put upon PS plate (Pre-Sensitized plate) which is prepared by piling up photo sensitive liquid on an aluminum substrate and the ray is irradiated from the printing paper side so as the information stored on the printing paper to be transcribed to the PS plate. The PS plate is the plate used for the purpose to print newspapers, and newspapers are prepared by an offset printing method. Usually, since the processes of outputting-developing-fixing of information to a printing paper can be easily influenced by conditions such as temperature, humidity, time or aging of time of a developing solution or a fixing solution, it is hard to obtain an image having a stabilized quality. Further, said processes needs a work in a dark room and gives bad influences to the environment caused by wasted liquid or wasted gas, and these are pointed out as serious problems.

Further, for example, in the case of a local newspaper, after printing paper is prepared based on electric information provided from the central newspaper firm, local news or advertisement columns are put in by patch work. These articles are read by a scanner and converted to electric information, and thus a revised printing paper is prepared. In the case when a typographical error is found out, above mentioned printing paper preparation process, namely, revision of printing paper by patch work, reading by a scanner, conversion to electric information, preparation of printing paper must be repeated again so as to complete a PS plate.

Accordingly, the improvement of said system which uses troublesome printing paper has been strongly required. And recently, the system characterized by recording information from a dry plotter, which is a laser recording device, to a dry film and then preparing a PS plate from the dry film has been developed. As a dry film, for example, a laser recording type thermal sensitive prove described in JP Laid Open Publication 2000-238436 containing a dye which carries out photo-thermal conversion by absorbing laser ray and a coloring material in a thermally sensitive layer can be considered to be useful. However, in the case of these conventional recording medium, although the recorded image can be read by a human's naked eye, when an optical readout such as a scanner is used, the high resolving degree can not be expected, therefore, the dry film is not sufficient for the actual use to be used instead of the printing paper in the plate preparation method.

Further, in the case of a dry plotter, the recording is carried out as follows. That is, the reverse surface to the recording layer of the recording medium is stuck to the surface of a rotary drum and the recording is carried out to the recoding layer located on the right side by rotating the rotary drum. Therefore, if the recording medium is not stuck contact to the drum, the distance between laser and the recording medium becomes alterable and focusing of laser becomes unstable and the precise record can not be obtained. Still more, in the case when a dry plotter is used for the plating system of newspaper, it is necessary to be proofread by a writing tool or not to cause breaking or staining at the handling.

The present invention is carried out concerning the above mentioned circumstances, and the object of the present invention is to provide a laser recording thermally sensitive recording medium which is excellent in laser recording property such as recording sensitivity, scanner readout of recorded image, sticking property to drum, writing property and resistance to abrasion.

### DISCLOSURE OF THE INVENTION

The inventors of the present invention have conduced intensive study to dissolve the above mentioned problem and have found out that the above mentioned problem can be dissolved by the following laser recording thermally sensitive recording medium, that is, a laser recording thermally sensitive recording medium comprising a thermally sensitive recording layer containing at least a photo absorbing material which absorbs laser ray and covert it to heat, an electron donning leuco dye and an electron accepting color developing agent on a substrate, wherein said electron donning leuco dye contains a leuco dye which absorbs the ray of visible range and a leuco dye having main wave length of absorption at the ray of 600 nm or longer, and accomplished the present invention.

In the present invention, the laser recording thermally sensitive recording medium which is excellent in recording sensitivity and readability of recorded image by a scanner can be obtained. The reason why is not clear, however, guessed as follows. In general, the readable wave length by a scanner is 630 nm around, while a specific type of scanner has the readable wave length at 680 nm around. On the contrary, in the case of ordinary thermally sensitive recording medium, since the leuco dye to be used is characterized that the absorption of wave length of said range or longer wave length are weak, it is hard to read the recorded image by a scanner. In the meanwhile, it is guessed that since the thermally sensitive recording medium of the present invention contains a leuco dye which indicates strong absorption at the wave length range readable by a scanner, the readability of it is improved. Further, in the present invention, the reason why is not clear, but the thermally sensitive recording medium can be used at longer readout wave length than 680 nm, and by this effect, the thermally sensitive recording medium of the present invention is recognized as a remarkably improved thermally sensitive recording medium. The reason why to cause above mentioned effect can be considered that because the absorbing ability of leuco dye having the main wave length of absorption for the ray of 600 nm or longer is improved by the interaction of two dyes having above mentioned properties.

### THE BEST EMBODYMENT TO CARRY OUT THE INVENTION

The present invention will be illustrated more in detail.

The photo absorbing material used in the present invention is the material which absorbs the ray of recording source, converts the absorbed ray to heat and radiates the heat to the outside. Therefore, the material which can absorb the ray of recording source as broad as possible and can convert it to heat, and the material whose absorption of ray is equal to the laser oscillation wave length range (approximately 760-1100 nm) or the material whose absorption of ray of closed infra red range is especially high is desirable from the view point of the effect of heat conversion and the generated heat quantity. Further, considering the readability by a scanner, since the maximum absorbing wave length of photo absorbing material and the main wave length of laser reading are existing at the outside of visible range, the photo absorbing material whose absorption of ray at visible ray range is small is desirable.

As the photo absorption material used in the present invention, a near-infrared absorbing agent which absorbs the ray having main wave length at near-infrared range and convert it to heat can be used. The near-infrared absorbing agent having absorption at wave length of 700-3000 nm range can be preferably used. Concretely, cyanine pigment, thiol nickel complex or squalilium pigment which are disclosed in well-known JP54-4152 Laid open publication, JP58-209594 Laid open publication or JP58-94494 Laid open publication can be mentioned. Further, nitroso compound and metal complex thereof disclosed in “Near-Infrared Absorbing Pigment” (Chemical Industries; vol 43, 1986 May.), polymethine pigment (cyanine pigment), complex of thiol with cobalt and paradium, phthalocyanine pigments, triallylmethane pigments, immonium or di-immonium pigments, naphthoquinone pigments, thiourea derivatives such as 1,3-diphenylthiourea and 1,3-dibenzylthiourea or a metal salt of organic acid can be mentioned,however, not intend to be limited to them. As the metal, a metal except IA group and IIA group of periodic table is used and the molecule weight of said metal is larger than 40.

Among these compounds, thiol-nickel complex compound is desirably used. Since thiol-nickel complex compound is characterized as to have strong ray absorbing ability and can carry out photo-heat conversion effectively even if the using amount of it is small, the thermally sensitive recording medium having high contrast controlling color development of ground color can be obtained. For the purpose to realize the high precision readability by a scanner, it is desirable that the difference between reflectance of image part and that of ground part is bigger than 60% when the ray of wave length longer than 600 nm is irradiated, more desirably is bigger than 70%. The thermally sensitive recording medium of the present invention is characterized that the difference between absorption intensity of image part and that of ground color part at the wave length of 630 nm which is the main wave length for the readout by a scanner, further at the longer wave length of 680 nm is large, and said large difference is the ground to accomplish the good contrast.

Among the electron donning leuco dye, as the leuco dye which absorbs the ray belonging to visible ray range, various well-known compounds can be used. These compounds can be used alone or can be used together with, and can be voluntarily selected according to the use or the desired quality. In the present invention, the leuco dye which absorbs the ray of visible range indicates the leuco dye which mainly absorbs the ray of wave length shorter than 600 nm around and does not have strong absorption at near-infrared or infrared range. Concretely, the following compounds can be mentioned, however, is not intending to be limited to them.

(1) Triarylmethane Compound

3,3′-bis(4-dimethylaminophenyl)-6-dimethylaminophthalide <commodity name; Crystal Violet Lacton, CVL>, 3-(4-dimethylamino-2-methylphenyl)-3-(4-dimethylaminophenyl)phthalide, 3,3′-bis(2-4(-dimethylaminophenyl)-2-(4-methoxyphenyl)ethenyl)-4,5,6,7-tetrachlorophthalide <NIR-Black>, 3,3′-bis(4-dimethylaminophenyl)phthalide <MGL>, 3-(4-dimethylaminophenyl)-3-(1,2-dimethylindol-3-yl)phthalide, 3-(4-dimethylaminophenyl)-3-(2-phenylindol-3-yl)phthalide, 3,3′-bis(4-ethylcarbazole-3-yl)-3-dimethylaminophthalide, 3,3′-bis(1-ethyl-2-methylindole-3-yl)phthalide <Indolyl Red>, 3,3′-bis(2-phenylindole-3-yl)-5-dimethylamonophthalide, tris(4-dimethylaminophenyl)methane <LCV> and others.

(2) Diphenylmethane Compound

4,4-bis(dimethylamino)benzhydrinebenzylether, N-halophenyl-leucoauramine, N-2,4,5-trichlorophenyl-leucoauramine and others.

(3) Xanthene Compound

rhodamineB-anilinolactam, 3-diethylamino-7-dibenzylaminofluorane, 3-diethylamino-7-butylaminofluorane, 3-diethylamino-7-anilinofluorane <Green-2>, 3-diethylamino-7-(2-chloroanilino)fluorane, 3-dibutylamino-7-(2-chloroanilino)fluorane <Th-107>, 3-diethylamino-7-(3-trifluoromethylanilino)fluorane <Black-100>, 3-diethylamino-6-methyl-7-anilinofluorane <OBD>, 3-dibutylamino-6-methyl-7-anilinofluorane <OBD-2>, 3-piperidino-6-methyl-7-anilinofluorane, 3-(N-isoamyl-N-ethylamino)-6-methyl-7-anilinofluorane <S-205>, 3-(N-ethyl-N-tolylamino)-6-methyl-7-anilinofluorane, 3-(N-cyclohexyl-N-methylamino)-6-methyl-7-anilinofluorane <PSD-150>, 3-diethylamino-6-chloro-7-(β-ethoxyethylamino)fluorane, 3-diethylamino-6-chloro-7-(γ-chloropropylamino)fluorane, 3-cyclohexylamino-6-chlorofluorane <OR-55>, 3-diethylamino-6-chloro-7-anilinofluorane, 3-(N-cyclohexyl-N-methylamino)-6-methyl-7-anilinofluorane, 3-diethylamino-7-phenylfluorane and others.

(4) Thiazine Compound

benzoylleucomethylene blue, p-nitrobenzoylleucomethylene blue and others.

(5) Spiro Compound

3-methylspirodinaphthopyrane, 3-ethylspirodinaphthopyrane, 3-benzylspirodinaphthopyrane or 3-methylnaphtho-(6′-methoxybenzo)spiropyrane can be mentioned.

(6) Pentadiene Compound

1,1,5,5-tetrakis(4-dimethylaminophenyl)-3-methoxy-1,4-pentadiene, 1,1,5,5-tetrakis(4-dimethylaminophenyl)-1,4-pentadiene and others.

In the present invention, besides above mentioned leuco dye, the leuco dye which has the main wave length of absorption to the ray longer than 600 nm is used. Especially, the leuco dye which indicates strong absorption to the wave length of 600-700 nm is desirably used. As the concrete example of said leuco dye, fluorane leuco dye and/or phthalide leuco dye are desirably used. Among the fluorane leuco dye, the use of 3-(N-p-tolyl-N-ethylamino)-(1′-N-ethyl-2′,2′,4′-trimethylpyridil)-[a]-fluorane <H-1046> is most desirable. Further, as the phthalide leuco dye, 3,3-bis(4-diethylamino-2-ethoxyphenyl)-4-azaphthalide <GN-2>, 3,6,6′-tris(dimethylamino)spiro [fluorene-9,3′-phthalide] <Green-118> or 3,3-bis(2-(4-diethylaminophenyl)-2-(4-methoxyphenyl)ethenyl)4,5,6,7-tetrachlorophthalide <NIR-Black> is desirable, however, 3,3-bis(4-diethylamino-2-ethoxyphenyl)-4-azaphthalide <GN-2> is the most desirable one.

As the electron accepting color developing agent used in the present invention, inorganic acidity compound such as activated clay, attapulgite, colloidal silica or aluminum silicate, A 4-hydroxybenzoic acid esters such as 4-hydroxybenzylbenzoate, 4-hydroxyethylbenzoate, 4-hydroxynormalpropylbenzoate, 4-hydroxyisopropylbenzoate or 4-hydroxybutylbenzoate, 4-hydroxyphthalic acid diesters such as 4-hydroxydimethylphthalate, 4-hydroxydiisopropylphthalate, 4-hydroxydibenzylphthalate or 4-hydroxydihexylphthalate, a phthalic acid monoesters such as monobenzylphthalate, monocyclohexylphthalate, monophenylphthalate or monomethylphenylphthalate, bishydroxyphenylsulfides such as bis-(4-hydroxy-3-tert-butyl-6-methylphenyl)sulfide, bis-(4-hydroxy-2,5-dimethylphenyl)sulfide or bis-(4-hydroxy-5-ethyl-2-methylphenyl)sulfide, bisphenols such as 3,4-bisphenol A, 1,1-bis(4-hydroxyphenyl)ethane, 2,2-bis(4-hydroxyphenyl)propane <bisphenol A>, bis(4-hydroxyphenyl)methane <bisphenol F>, 2,2-bis(4-hydroxyphenyl)hexane, tetramethyl bisphenol A, 1,1-bis(4-hydroxyphenyl)-1-phenylethane, 1,4-bis(2-(4-hydroxyphenyl)propyl)benzene, 1,3-bis(2-(4-hydroxyphenyl)propyl)benzene, 1,4-bis(4-hydroxyphenyl)cyclohexane, 2,2′-bis-(4-hydroxy-3-isopropylphenyl)propane or 1,4-bis(1-(4-(2-(4-hydroxyphenyl)-2-propyl)phenyl)ethyl)benzene, 4-hydroxyphenylarylsulfones such as 4-hydroxy-4′-isopropoxydiphenylsulfone <D-8>, 4-hydroxy-4′-methoxydiphenylsulfone or 4-hydroxy-4′-normalpropoxydiphenylsulfone, bishydroxyphenylsulfone such as bis(4-hydroxyphenyl)sulfone <bisphenol S>, tetramethyl bisphenol S, bis(3-ethyl-4-hydroxyphenyl)sulfone, bis(3-propyl-4-hydroxyphenyl)sulfone, bis(3-isopropyl-4-hydroxyphenyl)sulfone, bis(3-tert-butyl-4-hydroxy-6-methylphenyl)sulfone, bis(3-chloro-4-hydroxyphenyl)sulfone, bis(3-bromo-4-hydroxyphenyl)sulfone, 2-hydroxyphenyl-4′-hydroxyphenylsulfone 4-hydroxyphenylarylsulfonate such as 4-hydroxyphenylbenzenesulfonate, 4-hydroxyphenyl-p-tolylsulfonate or 4-hydroxyphenyl-p-chlorobenzenesulfonate, 4-hydroxybenzoyloxybenzoic acid esters such as 4-hydroxybenzoyloxybenzylbenzoate, 4-hydroxybenzoyloxyethylbenzoate, 4-hydroxybenzoyloxynormalpropylbenzoate, 4-hydroxybenzoyloxyisopropylbenzoate or 4-hydroxybenzoyloxybutylbenzoate, benzophenones such as 2,4-dihydroxybenzophenone, α,α′-bis-(3-methyl-4-hydroxyphenyl)-m-diisopropylbenzophenone or 2,3,4,4′-tetrahydroxybenzophenone, phenolic compounds such as N-stearyl-p -aminophenol, 4-hydroxysalicylanilido, 4,4′-dihydroxydiphenylether, n-butylbis(hydroxyphenyl) acetate, α,α′,α″-tris(4-hydroxyphenyl)-1,3,5-triisopropylbenzene, stearylgallate, 4,4′-thiobis(6-t-butyl-m-cresol), 2,2-bis(3-allyl-4-hydroxyphenyl)sulfone, bis(4-hydroxyphenyl)sulfide, bis(4-hydroxy-3-methylphenyl)sulfide, p-tert-butylphenol, p-phenylphenol, p-benzylphenol, 1-naphthol or 2-naphthol, thiourea compound such as N,N′-di-m-chlorophenylthiourea, aromatic carboxylic acid such as benzoic acid, p-tert-butyl benzoate, trichloro benzoate, 3-sec-butyl-4-hydroxy benzoate 3-sec-cyclohexyl-4-hydroxy benzoate, 3,5-dimethyl-4-hydroxy benzoate, terephthalic acid, salicylic acid, 3-isopropyl salicylate, 3-tert-butyl salicylate, 4-(2-(p-methoxyphenoxy)ethyloxy salicylate, 4-(3-(p-tolylsulfonyl)propyloxy salicylate or 5-(p-(2-(p-methoxyphenoxy)ethoxy)coumyl salicylate or 4-(3-(tolylsulfonyl)propyloxy salicylate, and salt of these aromatic carboxylic acid with polyvalent metal such as zinc, magnesium, aluminum, calcium, titanium, manganese, thin or nickel, further, organic acidic compound such as antipyrine complex of zincthiocyanate or complex zinc salt of terephtalicaldehyde acid with other organic carboxylic acid can be mentioned. These compounds can be used alone or can be used together with. Among these compounds, 4-hydroxyphenylarylsulfone represented by general formula (1) can be desirably used, further, 4-hydroxy-4′-isopropoxydiphenylsulfone is the most desirable one.

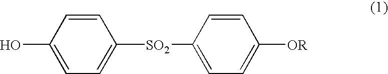

(in the formula, R is an alkyl group of carbon number 1-4)

Among the leuco dye having absorption closely to 680 nm wave length,

3,6,6′-tris (dimethylamino)spiro [fluorene-9,3′-phthalide] <Green-118> or 3,3-bis(2-(4-diethylaminophenyl)-2-(4-methoxyphenyl)ethenyl)4,5,6,7-tetra chlorophthalide <NIR-Black> has a following tendency when, for example, 4-hydroxyphenylarylsulfones e.g. 4-hydroxy-4′-isopopoxydiphenylsulfone is used as the color developing agent, that is, the dye which absorbs the ray of visible range develops color prior to these dyes and the readability of recorded image by a scanner is slightly deteriorated.

On the contrary, in the present invention, when 3-(N-p-tolyl-N-ethylamino)-(1′-N-ethyl-2′,2′,4′-trimethylpyridil)-[a]-fluorane <H-1046>, or 3,3-bis(4-diethylamino-2-ethoxyphenyl)-4-azaphthalide <GN-2> is used as the leuco dye which absorbs the ray of 600-700 nm wave length, the above mentioned problem can be effectively avoided, and these compounds can be used more desirably. And, additionally, when 3-dibutylamino-6-methyl-7-anilino fluorane <OBD-2> is used, since the thermally sensitive recording medium of excellent quality can be obtained, the use of <OBD-2> is more desirable.

Further, in the present invention, it is effective to use afore mentioned electron donning leuco dye and electron accepting color developing agent by pulverizing to fine particles so as the average particle size not to exceed 3 μm, desirably 1 μm more desirably 0.5 μm. In the case of thermally sensitive recording medium of the present invention, when laser ray is irradiated by the width of spot diameter, the photo absorbing material which exists directly under the irradiation part absorbs ray and convert it to heat. By this heat, the electron donning leuco dye and electron accepting color developing agent which are existing surrounding the photo absorbing material cause color developing reaction and an image can be obtained. If the particle size of these compounds is large, the dot diameter becomes large accordingly, and since the heat conversion becomes slow, the phenomenon of enlargement and blotting of dot diameter are easily generated. On the contrary, when the particle size of these compounds is small, the color developing reaction occurs in a moment and uniform dot can be effectively obtained and a precise image consisted of the assembling of small dots can be obtained.

In the case of recorded image consisted of the assembling of large dots, when compared with that of the assembling of small dots, the recorded image has the following tendency, that is, the both outer sides of a small line are uneven and the gap between dots is wide. Although said wider gap between dots is sufficient for the readout with the naked eye, it is considered that the accuracy for the optical readout is sometimes deteriorated. In the present invention, aiming to obtain a clear printing or a line drawing suited for the readout by a scanner, it is desirable that the size of a recorded dot is within ±5% to the size of the spot of laser ray, so as the size of a dot to be almost same to the size of a spot of laser ray, which is the light source, and to be uniform.

Further, the output power of the laser ray, which is the light source, has an influence to the size of a dot, and when the power is too strong, the calorific value by a photo absorbing material is increased and causes the enlargement of a dot or the blot. On the contrary, when the power is too weak, the dot size becomes too small and the reappearance is deteriorated. In the present invention, it is desirable that the output power is from 300 to 600 mW.

In the conventional thermally sensitive recording medium, a sensitizer is used aiming the improvement of sensitivity. In the thermally sensitive recording medium of the present invention, a sensitizer can be added in a thermally sensitive recording layer in response to the purpose. The concrete examples of the sensitizer are mentioned below, however not intending to be limited to them, and these sensitizers can be used together with. As the examples, stearic acid amide, methoxycarbonyl-N-steric acid benzamide, N-benzoylstearic acid amide, N-eicosanoic acid amide, ethylene bis stearic acid amide, behenic acid amide, methylenebis stearic acid amide, methylolamide, N-methylol stearic acid amide, dibenzylterephthalate, dimethylterephthalate, dioctylterephthlate, p-benzyloxybenzoic benzyl, 1-hydroxy-2-naphthoic acid phenyl, dibenzyloxalate, di-p-methylbenzyloxalate, di-p-chlorobenzyloxalate, 2-naphthylbenzyl ether, m-tarphenyl, p-benzylbiphenyl, 1,2-bis(phenoxymethyl)benzene <PMB-2>, tolylbiphenyl ether, di(p-methoxyphenoxyethyl)ether, 1,2-di(3-methylphenoxy)ethane, 1,2-di(4-methylphenoxy)ethane, 1,2-di(4-methoxyphenoxy)ethane, 1,2-di(4-clorophenoxy)ethane, 1,2-diphenoxyethane, 1-(4-methoxyphenoxy)-2-(2-methylphenoxy)ethane, p-methylthiophenylbenzyl ether, 1,4-di(phenylthio)butane, p-acetotoluidido, p-acetophenetidido, N-acetoacethyl-p-toluidine, di(-biphenylethoxy)benzene, p-di(vinyloxyethoxy)benzene and 1-isopropylphenyl-2-phenylethane can be mentioned. Ordinary, 0.1 to 10 weight parts of these mentioned sensitizers is used to 1 weight part of electron donning leuco dye.

To the thermally sensitive recording medium of the present invention, a preserving stabilizer can be used for the purpose of stabilization of the long term preservation. As the concrete examples of the preserving stabilizer, hindered phenol compound such as 1,1,3-tris(2-methyl-4-hydroxy-5-tert-butylphenyl)butane, 1,1,3-tris(2-methyl-4-hydroxy-5-cyclohehylphenyl)butane, 4,4′-butylidenebis(2-tert-butyl-5-methylphenol), 4,4′-thiobis(2-tert-butyl-5-methylphenol), 2,2′-thiobis(6-tert-butyl-4-methylphenol) or 2,2′-methylenebis(6-tert-butyl-4-methylphenol), 4-benzyloxy-4′-(2-methylglycidiloxy)diphenylsulfone or sodium2,2′-methylenebis(4,6-di-tert-butylphenyl)phosphete can be mentioned. Ordinary, 0.1 to 10 weight parts of these mentioned preserving sensitizers is used to 1 weight part of electron donning leuco dye.

As the concrete example of a binder used in the present invention, water soluble binder such as starchs, hydroxyethyl cellulose, methyl cellulose, carboxymethyl cellulose, gelatin, casein, gum arabic, polyvinylalcohol, denatured polyvinyl alcohol by carboxyl, denatured polyvinyl alcohol by acetoacetyl group, denatured polyvinyl alcohol by silicon, alkaline salt of isobutylene-maleic anhydride copolymer, alkaline salt of styrene-maleic anhydride copolymer, alkaline salt of ethylene-maleic anhydride copolymer or alkaline salt of styrene-acrylic acid copolymer, latexes such as styrene-butadiene copolymer or acrylonitrile-butadiene copolymer, water dispersible binder such as urea resin, melamine resin, amide resin or polyurethane resin can be mentioned. At least one kind of these mentioned binder is used by 15-80 weight % to the total solid weight in a thermally sensitive layer, an over coat layer, an intermediate layer, an undercoat layer and a back coat layer.

As a filler, an inorganic filler such as activated clay, clay, calcined clay, talc, kaoline, calcined kaoline, calcium carbonate, magnesium carbonate, barium carbonate, titanium dioxide, zinc oxide, silicone oxide or aluminum hydroxide, or an organic filler such as urea-formaldehyde resin, polystyrene resin or phenol resin can be used.

Still more, dispersing agent such as sodiumdioctylsulfosuccinate, surface active agent, defoamer, fluorescent brightening agent, slipping agent, UV absorbing agent or antioxidant can be used if desired.

As the substrate used for the thermally sensitive recording medium of the present invention, paper such as wood free paper, middle grade paper, recycled paper or coated paper can be mainly used, however, various non-woven cloth, plastic film, synthetic paper metal foil or a complex sheet combining these sheets can be also voluntarily used.

Furthermore, it is possible to form an over coat layer composed of polymer compound over the thermally sensitive recording layer for the purpose to improve the preserving property, and an under coat layer composed of polymer compound containing a filler under the thermally sensitive recording layer for the purpose to improve the color developing sensitivity. It is also possible to form an intermediate layer between the thermally sensitive recording layer and the over coat layer.

The formation of an over coat layer over the thermally sensitive recording layer and a back coat layer to the reverse surface of the substrate is much useful for the present invention. These layers are concerned to contribute for the improvement of sticking property of a dry plotter to a drum, writing ability and resistance to abrasion and to be useful for the improvement of the strength of the thermally sensitive recording layer. In particular, the sticking property to drum is an important ability in the present invention. In the present invention, by improving the adhesion of the thermally sensitive recording medium with a drum, the aberration of focussing of laser ray and the altering of distance are not caused, and the thermally sensitive recording medium which is characterized by not causing an uneven color development, the recorded density is uniform, contrast between image part and ground color is good and superior in readability by a scanner can be obtained.

It is necessary that the overcoat layer does not absorb the ray of wave length range of recording ray source or the ray of visible range, and not affect the color developing ability of the thermally sensitive recording layer. The important point of the over coat layer is to contain a filler and a binder as a main component and other additives can be added when the need is arisen. As the filler or the binder, above mentioned compounds which are used in the thermally sensitive recording layer, especially, it is desirable to use aluminum hydroxide as a filler and polyvinyl alcohol as a binder.

Regarding the containing amount of the filler and the binder in the over coat layer, the desirable amount of the filler is 10-90 weight % to the total solid weight of the over coat layer and desirably is 30-60 weight %. The amount of the binder is smaller than the amount which subtract the filler amount from the total solid weight of the over coat layer and more than 10 weight % to the total solid weight of the over coat layer is used. When the content of the filler is too small, since the amount of binder becomes relatively large, the binder penetrates into the thermally sensitive recording medium and hardened, and the hardened binder hinders the heat convey between ray absorbing material and leuco dye and color developing agent at the laser irradiation and consequently the sensitivity is deteriorated. Further, the writing ability by a red pencil at the proofreading is deteriorated. On the contrary, when the content of the filler is too large, the amount of the binder is reduced and therefore the surface toughness is weakened, and an over coat layer is removed by a small impulse, namely, the resistance to abrasion is deteriorated.

Regarding the back coat layer, it is important to contain a filler and a binder as a main component in it, further can use same filler and binder used in the over coat layer. The back coat layer is concerned to improve the smoothness of the rear surface of the thermally sensitive recording layer, control the air permeability and in particular contribute to the improvement of sticking property to drum. A filler and a binder in the back coat layer can be contained by voluntarily adjusting the amount for use.

Further, in the present invention, it is desirable that the thermally sensitive recording medium has high air permeability higher than 5000 sec. In the case of a dry plotter, the thermally sensitive recording medium of the present invention the reverse surface to the recording layer is stuck to a rotary drum by aspiration from the rotary drum and records to the recording surface while rotating. Therefore, if the conventional silver salt film is used, the aspiration is easy, however, in the case when paper is used as the substrate, the sticking by aspiration is not easy because of air leaking. Concerning this problem, the inventors of the present invention have found out that the thermally sensitive recording medium having good sticking property to drum can be obtained by setting air permeability to 5000 seconds or more. The air permeability can be adjusted by the presence of an over coat layer and back coat layer, by coating amount of each layer including said layers and thermally sensitive layers, by uniformity of these coating layer, further by the blending ratio of pulp to paper substrate and water penetration, and by well known various method in the paper industry field.

Furthermore, in the present invention, it is desirable that the water content in paper is 10% or under 10%, more desirably is 5% or under 5%. The thermally sensitive recording medium of the present invention is needed to prevent the excess curling, and when the curling is too much, the problem that the sticking property to a drum is deteriorated or removed from a drum during the recording process. For the purpose to prevent the curling problem, it is effective to maintain the content of water in paper to the lower level and to control the change of water contents in paper. When the content of water in paper is too much, the sticking property to a drum is deteriorated and it becomes difficult to obtain an excellent recorded image. Also the water content in paper can be controlled by various well-known methods in the paper manufacturing field, for example, drying condition, filler contents or pulp blending ratio.

The thermally sensitive recording medium of the present invention can be prepared according to the conventional well-known method using various materials mentioned above. Regarding the method for preparation of a coating for each layers of the thermally sensitive recording material is not restricted, and generally can be prepared by mixing and stirring photo absorbing material, electron donning leuco dye, electron receiving color developing agent, additionally, binder and filler and slipping agent which are added when the need is arisen, using water as a dispersing medium. As the method to prepare an aqueous coating using leuco dye and a color developing agent, following methods can be mentioned. The method to pulverize leuco dye and a color developing agent separately using a sand grinder, an attriter or a ball mill and disperse them in water then mixing together, or the method to prepare micro capsules in which leuco dye or a color developing agent is immobilized then obtain aqueous coating are well-known. The ratio of using amount of leuco dye and a color developing agent is voluntarily selected according to the kind of leuco dye and a color developing agent and is not particularly restricted, however, 1-50 weight parts, desirably 2-10 weight parts of color developing agent is used to 1 weight part of leuco dye. Regarding a photo absorbing material, 0.1-50 weight parts of it, desirably 0.3-5 weight parts, is used to the total solid weight of thermally sensitive recording layer. In the present invention, when the photo absorbing material is used together with a sensitizer by previously dispersed, dissolved or fused, the photo absorbing property can be enhanced, therefore said method is effective. Further, it is desirable that the photo absorbing material is pulverized to fine particles smaller than 3 μm of average particle size after dispersed or mixed with a sensitizer. As a sensitizer, same ones used in the thermally sensitive recording layer can be used.

It is desirable to pulverize a near-infrared ray absorbing agent and color developing materials (leuco dye, color developing agent, sensitizer) to fine particles whose average particle size is not to exceed 3 μm. The reason why is thought as follows. That is, by pulverizing materials finer, the dot size of color developed printed part becomes same size to the size of spot of laser ray, which is ray source, and forms uniform dots, and clear printing or a line drawing suited for the readout by a scanner are obtained.

The method for forming of each layer of thermally sensitive recording layer is not restricted and methods such as air knife coating, Valiber blade coating, pure blade coating, rod blade coating, short dwell coating, curtain coating or die coating can be voluntarily selected. For example, a coating for thermally sensitive recording layer is coated on a substrate and dried, then a coating for over coat layer is coated over the thermally sensitive recording layer and dried. Further, the coating amount of the coating for thermally sensitive recording layer is approximately 2-12 g/m², desirably 3-10 g/m² by dry weight and, the coating amount of the coating for under coat layer, intermediate layer or over coat layer is approximately 0.1-15 g/m², desirably 0.5-7 g/m² by dry weight.

Furthermore, the thermally sensitive recording medium of the present invention is possible to provide a back coat layer at the reverse side of the substrate so as to improve the preservability more. Still further, after each layer is formed, it is possible carry out the smoothing treatment such as super calendering.

### EXAMPLE

The present invention will be illustrated more concretely according to the Examples and the Comparative Examples, however, not intended to be limited by them. In the Examples and the Comparative Examples, “parts” and “%” indicate “weight parts” and “weight %”.

### Example 1

A Solution (Dispersion of Color Developing Agent)

| | |
|---|---|
| 4-hydroxy-4′-isopropoxydephenylsulfone <D-8> | 6.0 parts |
| 10% aqueous solution of polyvinylalcohol | 20.0 parts |
| water | 10.0 parts |

Mixture of above mentioned components is ground to average particle size of 1 μm using a sand grinder.

B Solution (Dispersion of Photo Absorbing Material)

Bis(3,4,5,6-tetrachlorophenyl-1,2-dithiol)Ni tetrabutylammonium complex

| | |
|---|---|
| <product of Mitsui Chemical Co., Ltd., PA-1005> | 1.0 parts |
| 1,2-bis(phenoxymethyl)benzene <PMB-2> | 5.0 parts |
| 10% aqueous solution of polyvinylalcohol | 10.0 parts |
| water | 6.0 parts |

Mixture of above mentioned components is ground to average particle size of 1 μm using a sand grinder.

C Solution (Dispersion of Dye)

| | |
|---|---|
| 3-dibutylamino-6-methyl-7-anilino fluorane <OBD-2> | 3.0 parts |
| 10% aqueous solution of polyvinylalcohol | 5.0 parts |
| water | 2.0 parts |

Mixture of above mentioned components is ground to average particle size of 1 μm using a sand grinder.

D Solution (Dispersion of Leuco Dye which Absorbs Ray Longer than 600 nm)

3,3-bis(4-diethylamino-2-ethoxyphenyl)-4-azaphthalide <GN-2 > 1.0 parts

| | |
|---|---|
| 10% aqueous solution of polyvinylalcohol | 5.0 parts |
| water | 2.0 parts |

The mixture of above mentioned components is ground to average particle size of 1 μm using a sand grinder.

Then above mentioned dispersions are mixed by the following ratio and a coating is obtained.

| | |
|---|---|
| A solution | 40.0 parts |
| B solution | 20.0 parts |
| C solution | 10.0 parts |
| D solution | 10.0 parts |
| 30% silica dispersion | 30.0 parts |

The obtained coating is coated on the one surface of 60 g/m² paper so as the coating amount to be 7.0 g/m² and dried, and the laser recording thermally sensitive recording medium is prepared.

### Example 2

By the same process to Example 1 except changing leuco dye which absorbs ray longer than 600 nm to 3-(N-p-tolyl-N-ethylamino)-(1′-N-ethyl-2′,2′,4′-trimethylpyridil)-[a]-fluorane <H-1046>, the laser recording thermally sensitive recording medium is prepared.

### Example 3

By the same process to Example 1 except changing electron accepting color developing agent to 4,4′-dihydroxydiphenylsuofone <bisphenol-S>, the laser recording thermally sensitive recording medium is prepared.

### Example 4

By the same process to Example 1 except changing leuco dye which absorbs ray of 600-700 nm to 3,6,6′-tris(dimethylamino)spiro [fluorine-9,3′-phthalide] <green-118>, the laser recording thermally sensitive recording medium is prepared.

### Example 5

By the same process to Example 1 except changing leuco dye which absorbs ray of 600-700 nm to 3,3′-bis(2-(4-dimethylaminophenyl)-2-(4-methoxyphenyl)ethenyl-4,5,6,7-tetrachlorophthalide <NIR-Black>, the laser recording thermally sensitive recording medium is prepared.

### Example 6

By the same process to Example 1 except changing the particle size of each materials of dispersion to 0.5 μm, the laser recording thermally sensitive recording medium is prepared.

### Example 7

To the laser recording thermally sensitive recording medium prepared in Example 1, the following over coat layer and back coat layer is provided.

<Formation of the Over Coat Layer>

| | |
|---|---|
| 50% dispersion of aluminumhydroxide | 10.0 parts |
| 10% aqueous solution of polyvinylalcohol | 30.0 parts |
| water | 5.0 parts |

The mixture of above mentioned components is ground to average particle size of 1 μm using a sand grinder. The obtained coating is coated on the thermally sensitive recording layer so as the coating amount to be 2.0 g/m² and dried.

<Formation of the Back Coat Layer>

The coating prepared for over coat layer is coated on the thermally sensitive recording layer and on the reverse surface of the substrate so as the coating amount to be 2.0 g/m² and dried.

### Comparative Example 1

By the same process to Example 1 except using D solution (Dispersion of leuco dye which absorbs ray longer than 600 nm) of Example 1, the laser recording thermally sensitive recording medium is prepared.

### Comparative Example 2

By the same process to Example 1 except using B solution (Dispersion of photo absorbing material) of Example 1, the laser recording thermally sensitive recording medium is prepared.

Evaluation Test

To the laser recording thermally sensitive recording media obtained in Examples 1-5 and Comparative Example 1-2, recording by laser is carried out using dry plotter-GX-3700 (wavelength 830 nm, laser output 400 mW, spot diameter (beam width) 10 μm) and the color density of the printed part and the ground color part is measured by Macbeth densitometer RD-19. And the reflectance of the printed part against the ray of 630 nm and 680 nm wavelength are measured. When the value of reflectance is small, the contrast with the ground color part is large. Further, the readability when readout by a scanner (readout wavelength is 680 nm) is indicated as,

◯: can be readout well

X: accuracy for readout is bad (or can not be readout)

The results are summarized in Table 1.

TABLE 1

| | Macbeth | | | | |
|---|---|---|---|---|---|
| | concentration | | Reflectance of | | |
| | Printed | Ground | printed part | | Readability |
| | part | part | 630 nm | 680 nm | by a scanner |
| Example 1 | 1.53 | 0.10 | 5.0 | 6.0 | ◯ |
| Example 2 | 1.52 | 0.12 | 5.2 | 6.5 | ◯ |
| Example 3 | 1.41 | 0.10 | 6.7 | 7.5 | ◯ |
| Example 4 | 1.42 | 0.15 | 6.0 | 7.2 | ◯ |
| Example 5 | 1.45 | 0.12 | 5.7 | 6.3 | ◯ |
| Comparative | 1.51 | 0.10 | 6.2 | 30.0 | X |
| Example 1 | | | | | |
| Comparative | 0.15 | 0.14 | 80.0 | 70.0 | X |
| Example 2 | | | | | |

Regarding the laser recording thermally sensitive recording media obtained in Example 6 and Comparative Example 1, recording by laser is carried out by same method as mentioned above, and dot size is measured by microscope observation and homogeneity of image is evaluated as follows.

◯: unevenness is not observed on both outer sides of small line

X: unevenness is observed on both outer sides of small line

Also scanner readability is evaluated by same method as mentioned above. The results are summarized in Table 2.

TABLE 2

| | Printed part | | Homogeneity | |
|---|---|---|---|---|
| | Macbeth | Dot size | of | Readability |
| | concentration | (μm) | image | by a scanner |
| Example 1 | 1.5 | 101 | ◯ | ◯ |
| Comparative | 1.51 | 10.6 | X | X |
| Example 1 | | | | |

Regarding the laser recording thermally sensitive recording media obtained in Example 7 and Comparative Example 1, recording by laser is carried out by same method as mentioned above, and evaluated according to the following evaluation tests. The air permeability is measured by the method prescribed in JIS-P-8117 and water content in paper is measured by the method prescribed in JIS-P-8127.

Sticking to dram: The state of recording using above mentioned dry plotter is observed and evaluated by the following standard.

◯: not removed by rotation

Δ: easily removed by rotation

X: removed immediately by rotation

Writing ability: The feeling at writing using a red pencil on the surface to which a thermally sensitive recording layer is formed is evaluated by the following standard.

◯: can write smoothly

X: hard to write

Resistance to rubbing: The surface to which a thermally sensitive recording layer is formed is scratched with a nail and the state of the scratched surface is evaluated by visual inspection by the following standard.

◯: not injured

X: injured

Also scanner readability is evaluated by same method as mentioned above. The results are summarized in Table 3.

TABLE 3

| | Macbeth | | Water | | | | |
|---|---|---|---|---|---|---|---|
| | conc. of | Air | cont. in | Readability | | | |
| | printed | permeability | paper | by a | Sticking | Writing | Resistance |
| | part | (sec) | (%) | scanner | to dram | ability | to rubbing |
| Example 7 | 1.57 | 20000 | 7 | ◯ | ◯ | ◯ | ◯ |
| Comparative | 1.51 | 400 | 7 | X | X | X | X |
| Example 1 | | | | | | | |

### Industrial Applicability

As mentioned above, the laser recording thermally sensitive recording medium of the present invention is excellent in recording density and scanner readability. Therefore, in the field of a news paper plate making, it can be used as a recording medium of novel system, and is very useful.

1. A laser recording thermally sensitive recording medium comprising a thermally sensitive recording layer containing at least a photo absorbing material which absorbs laser ray and covert it to heat, an electron donning leuco dye and an electron accepting color developing agent on a substrate, wherein said electron donning leuco dye contains a leuco dye which absorbs the ray of visible range and a leuco dye having main wave length of absorption at the ray of 600 nm or longer than 600 nm.

2. The thermally sensitive recording medium of claim 1, wherein the leuco dye having main wave length of absorption at the ray of 600 nm or longer than 600 nm is 3-(N-p-tolyl-N-ethylamino)-(1′-N-ethyl-2′,2′,4′-trimethylpyridil)-[a]-fluorane and/or 3,3-bis(4-diethylamino-2-ethoxyphenyl)-4-azaphthalide.

3. The laser recording thermally sensitive recording medium of claim 1 or claim 2, wherein the electron accepting color developing argent is at least one 4-hydroxyphenylarylsulfone represented by general formula (1),

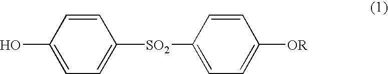

4. The laser recording thermally sensitive recording medium in accordance with any one of claims 1 to 3, wherein the photo absorbing material contains at least one thiol-nickel complex compound.

5. The laser recording thermally sensitive recording medium in accordance with any one of claims 1 to 4, wherein the average particle size of the electron donning leuco dye and the electron accepting color developing agent do not exceed 3 μm.

6. The laser recording thermally sensitive recording medium in accordance with any one of claims 1 to 5 further providing an over coat layer containing a filler and a binder as main component on the thermally sensitive recording layer and a back coat layer containing a filler and a binder as main component on the reverse surface of the substrate.

7. The laser recording thermally sensitive recording medium of claim 6, wherein air permeability prescribed by JIS-P-8117 is 5000 seconds or more.

8. The laser recording thermally sensitive recording medium of claim 6 or claim 7, wherein water content in paper is 10% or less.
